(19) United States
(12) Patent Application Publication
(10) Pub. No.: US 2019/0244139 A1
(43) Pub. Date: Aug. 8, 2019

(54) USING META-LEARNING FOR AUTOMATIC GRADIENT-BASED HYPERPARAMETER OPTIMIZATION FOR MACHINE LEARNING AND DEEP LEARNING MODELS

(71) Applicant: Oracle International Corporation, Redwood Shores, CA (US)

(72) Inventors: VENKATANATHAN VARADARAJAN, Austin, TX (US); SANDEEP AGRAWAL, San Jose, CA (US); SAM IDICULA, Santa Clara, CA (US); NIPUN AGARWAL, Saratoga, CA (US)

(21) Appl. No.: 15/914,883

(22) Filed: Mar. 7, 2018

Related U.S. Application Data
(60) Provisional application No. 62/625,811, filed on Feb. 2, 2018.

(51) Int. Cl. G06N 99/00; G06N 5/04

(52) U.S. Cl. CPC G06N 99/005; G06N 5/04

(57) ABSTRACT

Techniques are provided herein for optimal initialization of value ranges of machine learning algorithm hyperparameters and other predictions based on dataset meta-features. In an embodiment for each particular hyperparameter of a machine learning algorithm, a computer invokes, based on an inference dataset, a distinct trained metamodel for the particular hyperparameter to detect an improved subrange of possible values for the particular hyperparameter. The machine learning algorithm is configured based on the improved subranges of possible values for the hyperparameters. The machine learning algorithm is invoked to obtain a result. In an embodiment, a gradient-based search space reduction (GSSR) finds an optimal value within the improved subrange of values for the particular hyperparameter. In an embodiment, the metamodel is trained based on performance data from exploratory sampling of configuration hyperspace, such as by GSSR. In various embodiments, other values are optimized or intelligently predicted based on additional trainable metamodels.

### PRIORITY CLAIM AND CROSS-REFERENCE TO RELATED APPLICATION

This application claims the benefit of Provisional U.S. Patent Application No. 62/625,811, titled “USING META-LEARNING FOR AUTOMATIC GRADIENT-BASED HYPERPARAMETER OPTIMIZATION FOR MACHINE LEARNING AND DEEP LEARNING MODELS”, filed Feb. 2, 2018, the entire contents of which is incorporated by reference as if fully set forth herein. This application is further related to U.S. patent application Ser. No. 15/885,515, entitled “GRADIENT-BASED AUTO-TUNING FOR MACHINE LEARNING AND DEEP LEARNING MODELS”, filed by Venkatanathan Varadarajan, et al. on Jan. 31, 2018, the entire contents of which is hereby incorporated by reference as if fully set forth herein.

### FIELD OF THE DISCLOSURE

This disclosure relates to meta-learning based machine-learning. Presented herein are techniques for optimal initialization of value ranges of machine learning algorithm hyperparameters and other predictions based on dataset meta-features.

### BACKGROUND

Data analytics and modeling problems using machine learning are becoming popular and often rely on data science expertise to build reasonably accurate machine learning (ML) models. Such modeling involves picking an appropriate model and tuning the model to a given dataset. Model tuning is the most time consuming and ad-hoc step that heavily relies on data scientist. Despite attempts to mitigate these issues using various techniques, challenges in automating hyperparameter optimization remain. Even the best optimization techniques have the following challenges:
Hyperparameter automation is incomplete. User input is needed, such as for reasonable default values or subranges within a wide range of possible hyperparameter values.
Local extrema distract gradient techniques. Generalizing hyperparameter tuning for any model and dataset combination is difficult or impossible. The surface of the optimization search space significantly varies across datasets.
Categorical hyperparameters resist tuning. Categorical hyperparameters do not have gradients. Categorical hyperparameter heuristics increase training time linearly with the number of discrete categories (i.e. values) per categorical hyperparameter.
Dataset and model specific training time is unstable. Arriving at a generalized cost model that predicts the training time for a given choice of hyperparameter is crucial to efficiently navigate the parameter space during auto-tuning. However, cost is specific to a model implementation and intrinsically dependent on dataset characteristics. Thus, cost has been unpredictable.

Optimization approaches such as grid search and random search rely on Bayesian techniques that spontaneously work. However, these approaches neglect the full potential of pre-trained models and meta-learning, which require more front-loaded investment and promise improved training efficiency and improved production quality.

### BRIEF DESCRIPTION OF THE DRAWINGS

In the drawings:

FIG. 1 is a block diagram that depicts an example computer that optimally initializes value ranges of machine learning algorithm hyperparameters, in an embodiment;

FIG. 2 is a flow diagram that depicts an example process for optimally initializing value ranges of machine learning algorithm hyperparameters, in an embodiment;

FIG. 3 is a block diagram that depicts an example computer that performs a gradient-based search space reduction (GSSR) that is modified for use with an improved initial subrange of hyperparameter values, in an embodiment;

FIG. 4 is a block diagram that depicts an example computer that predicts an improved value subrange that is sensitive to an actual dataset, in an embodiment;

FIG. 5 is a block diagram that depicts an example computer that trains a hyperparameter metamodel to predict an improved subrange, in an embodiment;

FIG. 6 is a flow diagram that depicts an example process for training a hyperparameter metamodel to predict an improved subrange, in an embodiment;

FIG. 7 is a block diagram that depicts an example computer that trains a categorical hyperparameter metamodel to predict an optimal categorical value for the hyperparameter, in an embodiment;

FIG. 8 is a flow diagram that depicts an example process for stimulating multiple (e.g. ensemble of) already trained per-value categorical hyperparameter metamodels to predict an optimal categorical value for the hyperparameter for a given inference dataset, in an embodiment;

FIG. 9 is a block diagram that depicts an example computer that trains a hyperparameter metamodel to predict an optimal separation distance between points of a sampling pair for the hyperparameter, in an embodiment;

FIG. 10 is a flow diagram that depicts an example process for training a numerical hyperparameter metamodel to predict an optimal separation distance between points of a pair for the hyperparameter, in an embodiment;

FIG. 11 is a block diagram that depicts an example computer that trains a metamodel to predict a duration needed to train a machine learning algorithm with a given configuration for a given training dataset, in an embodiment;

FIG. 12 is a flow diagram that depicts an example process for training a metamodel to predict a duration needed to train a machine learning algorithm with a given configuration for a given training dataset, in an embodiment;

FIG. 13 is a block diagram that illustrates a computer system upon which an embodiment of the invention may be implemented;

FIG. 14 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Example Computer
   2.1 Machine Learning Algorithms
   2.2 Hyperparameters
   2.3 Meta-Models
   2.4 Result
3.0 Example Value Range Improvement Process
4.0 Enhancements For Gradient-Based Search Space Reduction (GSSR)
   4.1 Local Extrema
   4.2 Epoch Sequence
   4.3 Gradient
5.0 Dataset Sensitivity
   5.1 Meta-Features
   5.2 Inference Dataset
   5.3 Inferencing
6.0 Metamodel Lifecycle
   6.1 Metadata
7.0 Meta-Learning
   7.1 Scores
   7.2 Subrange Classification
   7.3 Dataflow
8.0 Example Metamodel Training Process
9.0 Categorical Hyperparameter
   9.1 Ensemble
10.0 Example Category Optimization Process
11.0 Sampling Optimization
12.0 Example Gradient Prediction Process
13.0 Training Budget
14.0 Example Duration Prediction Process
15.0 Hardware Overview
16.0 Software Overview
17.0 Cloud Computing

### 1.0 General Overview

Techniques are provided herein for optimal initialization of value ranges of machine learning algorithm hyperparameters and other predictions based on dataset meta-features. In an embodiment for each particular hyperparameter of a machine learning algorithm, a computer invokes, based on an inference dataset, a distinct trained metamodel for the particular hyperparameter to detect an improved subrange of possible values for the particular hyperparameter. The machine learning algorithm is configured based on the improved subranges of possible values for the hyperparameters. The machine learning algorithm is invoked to obtain a result.

In an embodiment, a gradient-based search space reduction (GSSR) finds an optimal value within the improved subrange of values for the particular hyperparameter. In an embodiment, the metamodel is trained based on dataset meta-features and performance metrics from exploratory sampling of configuration hyperspace, such as by GSSR. In various embodiments, other values are optimized or intelligently predicted based on additional trained/trainable metamodels.

### 2.0 Example Computer

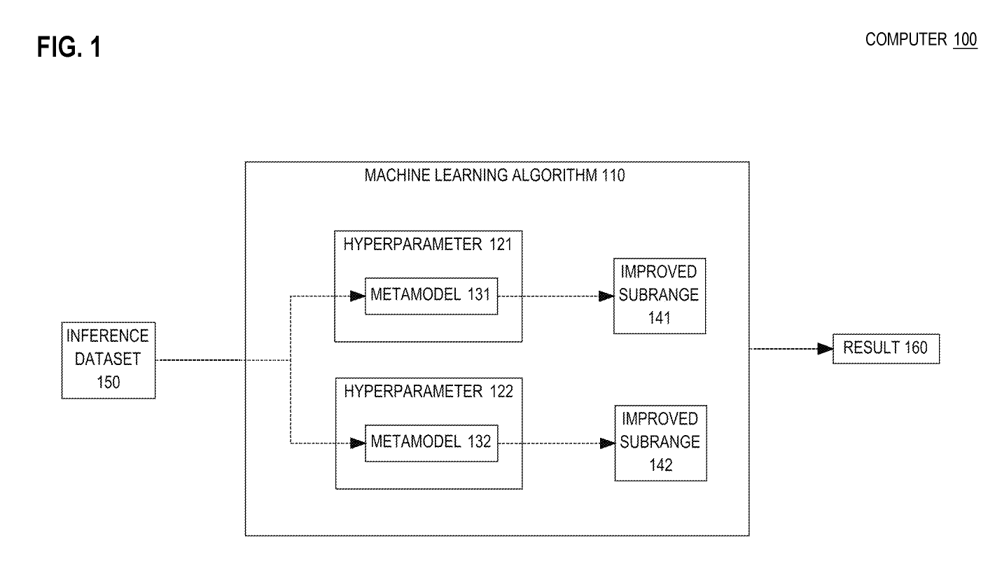

FIG. 1 is a block diagram that depicts an example computer 100, in an embodiment. Computer 100 optimally initializes value ranges of machine learning algorithm hyperparameters. Computer 100 may be one or more computers such as an embedded computer, a personal computer, a rack server such as a blade, a mainframe, a virtual machine, or any computing device that uses scratch memory during numeric and symbolic processing.

### 2.1 Machine Learning Algorithms

Computer 100 contains or accesses a specification of machine learning algorithms, such as 110 that may perform analysis such as classification, regression, clustering, or anomaly detection. For example, algorithm 110 may be a support vector machine (SVM), an artificial neural network (ANN), a decision tree, or a random forest.

Machine learning algorithm 110 is trainable and perhaps due for tuning (retraining) or not yet trained. Algorithm 110 need not be ready (trained) for immediate use on inference dataset 150. Inference dataset 150 may be empirical data, either exhaustive or representative, that algorithm 110 may eventually use for training or inference such as data mining.

Machine learning has hundreds of algorithms and is still rapidly growing. Many of these algorithms are readily available in reusable libraries such as TensorFlow and scikit-learn.

### 2.2 Hyperparameters

Features of an algorithm are referred to as hyperparameters. For example, algorithm 110 has at least hyperparameters 121-122.

If algorithm 110 is a support vector machine, then hyperparameters typically include C and gamma. If algorithm 110 is a neural network, then hyperparameters may include features such as a count of layers and/or a count of neurons.

Algorithm 110 may have many configuration alternatives based on hyperparameter values. Each distinct configuration of algorithm 110 is based on a distinct set of values for hyperparameters 121-122.

Each of hyperparameters 121-122 may logically be a separate axis in a multidimensional hyperspace. Each distinct configuration of algorithm 110 corresponds to a distinct point in that hyperspace.

Some of hyperparameters 121-122 may be continuous variables, meaning that even a tiny subrange of such a hyperparameter may contain an infinite amount of points. Due to such intractable combinatorics, computer 100 should not consider many or most of the points in the hyperspace.

Entire portions of the hyperspace represent suboptimal configurations that should be ignored. Although computer 100 may have ways of optimally fine-tuning hyperparameter values, computer 100 uses the following mechanisms to initially prune each hyperparameter's value range to obtain narrowed/improved value ranges.

For example, improved subranges 141-142 may be obtained for respective hyperparameters 121-122, for which computer 100 has a separate metamodel, such as 131-132, for each respective hyperparameter. Each of metamodels 131-132 was trained to predict an optimal improved subrange of possible values for a respective hyperparameter such as 121-122. For example, metamodel 131 was trained by observing the performance of instances of algorithm 110 that had configurations that had exploratory (e.g. landmark) values for hyperparameter 121.

Training of algorithm 110 is computationally very expensive, which may be aggravated by the amount of raw data in inference dataset 110. Computational feasibility may require that computer 100 (or another computer) train only one or a small subset of configurations for algorithm 110.

Ideally, computer 100 would select (for training and/or inference) a few configurations of algorithm 110 that could produce the best (most accurate, least error) results with inference dataset 110. However, because some or most configurations of algorithm 110 may still need training or retraining, accuracy prediction may be difficult or impossible.

### 2.3 Metamodels

Each of metamodels 131-132 is itself an instance of trainable regression algorithm, although not the same algorithm for which the metamodels are trained for. For example, metamodels 131-132 may each be a distinct random forest that is already trained to predict improved value subranges for hyperparameters of algorithm 110, which may be support vector machine or a neural network instead of a random forest.

Training of metamodels is discussed later herein. When predicting an improved value subrange for a hyperparameter of an algorithm, a metamodel should consider features of the algorithm and features of inference dataset 110, also as discussed later herein.

### 2.4 Result

Improved subranges 141-142 may be used as initial subranges from which sophisticated searching for optimal hyperparameter values may begin. With detected optimal values, machine learning algorithm 110 may be precisely configured for intensive training, such as with inference dataset 150 or a larger training dataset.

Thus, improved subranges 141-142 are important for full and final training of algorithm 110 with less computing than the state of the art. A well trained machine learning algorithm 110 can next be deployed into production (e.g. in the wild) to outperform (i.e. better accuracy) the state of the art.

Computer 100 (or a downstream computer) may then use machine learning algorithm 110 to achieve a material result, such as 160. For example, computer 100 may use inference dataset 150 (or a larger dataset that includes 150) to actually train one or a few alternate configurations of algorithm 110. For example, result 160 may be a well configured and well trained instance of algorithm 110 that is ready (e.g. deployed) for production use.

The techniques herein improve the performance of computer 100 itself in various ways. By pruning the hyperparameter hyperspace, speculative training of an excessive count of hyperparameter configurations is avoided. By scoring based on fitness for actual dataset meta-feature values, contextual suitability of optimization is increased.

Thus, subsequent full and final training (e.g. by computer 100) occurs faster. Likewise, trained algorithm 110 achieves higher accuracy in production use (e.g. by computer 100). Thus, computer 100 is accelerated as an algorithm training computer and is more reliable (accurate) as a production inference computer. By reducing the computational burden of these activities, the techniques herein are accelerated (save time) and save energy.

### 3.0 Example Value Range Improvement Process

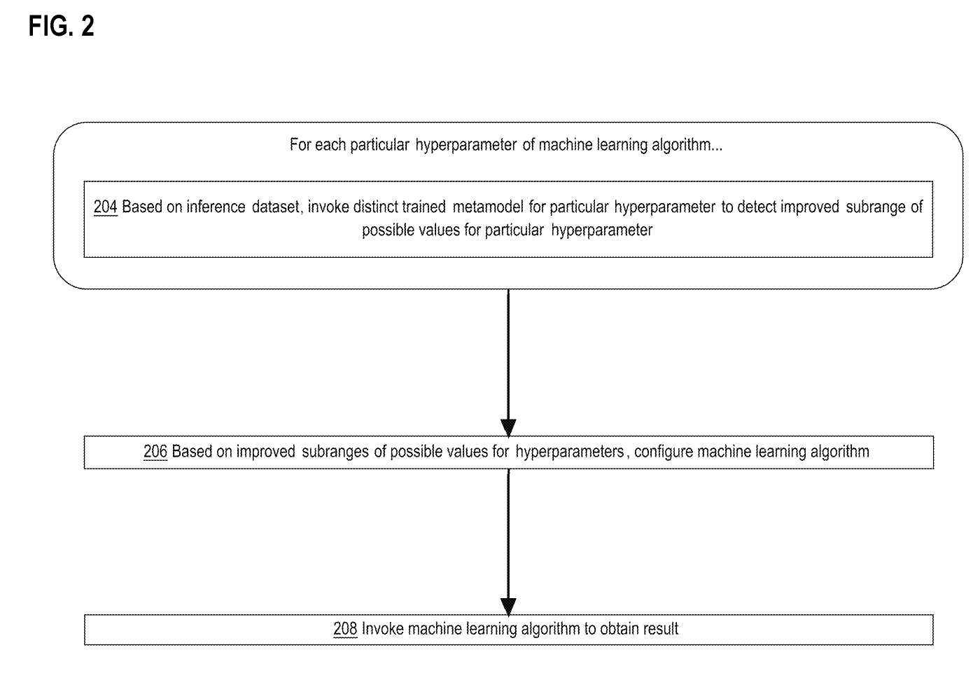

FIG. 2 is a flow diagram that depicts computer 100 optimally initializing value ranges of machine learning algorithm hyperparameters, in an embodiment. FIG. 2 is discussed with reference to FIG. 1.

The lifecycle of a machine learning algorithm progresses through phases of configuration, training, and inferencing. Algorithm 110 and metamodel 131 are separate machine learning algorithms that may independently transition through their lifecycles.

In this example, a metamodel inferences so that a separate algorithm can be optimally configured. FIG. 2 depicts inferencing by an already trained metamodel and also depicts the entire lifecycle of a separate algorithm that the metamodel assists. Training a metamodel itself is a different scenario that is discussed later herein.

Inferencing by an already trained metamodel occurs in step 204. Because each hyperparameter has its own metamodel, step 204 is repeated for each hyperparameter of the separate algorithm.

Based on an inference dataset, a distinct trained metamodel for a particular hyperparameter is invoked to detect an improved subrange of possible values for the particular hyperparameter. For example, stimulation by information about inference dataset 150 causes already trained metamodel 131 to emit improved subrange 141 that predicts an optimal region of a configuration hyperspace to later search for an optimal value for hyperparameter 121. After step 204 finishes, the configuration hyperspace has been well pruned in preparation for sophisticated optimization.

In step 206, the machine learning algorithm is configured based on improved subranges of possible values for hyperparameters. For example a sophisticated search, such as gradient-based search space reduction (GSSR), may search within improved subrange 141 to find an optimal value for hyperparameter 121.

During step 206, all improved subranges 141-142 may be fully reduced to respective optimal values. Machine learning algorithm 110 may be configured with those detected optimal values.

Thus, step 206 causes algorithm 110 to be optimally configured especially for training with inference dataset 150 or a related training dataset. After step 206 finishes, algorithm 110 is well configured and ready for training.

Actual training of algorithm 110 may also occur in step 206. Thus after step 206 finishes, algorithm 110 may already be fully and finally trained and ready for production use, such as inferencing.

Step 208 invokes the machine learning algorithm to obtain a result. For example, computer 100 may stimulate already trained machine learning algorithm 110 with inference dataset 150 or any somewhat similar inference dataset to achieve result 160. For example, algorithm 110 may be stimulated with a human fingerprint and cause a meaningful result such as unlocking a smartphone or refusing to do so.

### 4.0 Enhancements for Gradient-Based Search Space Reduction (GSSR)

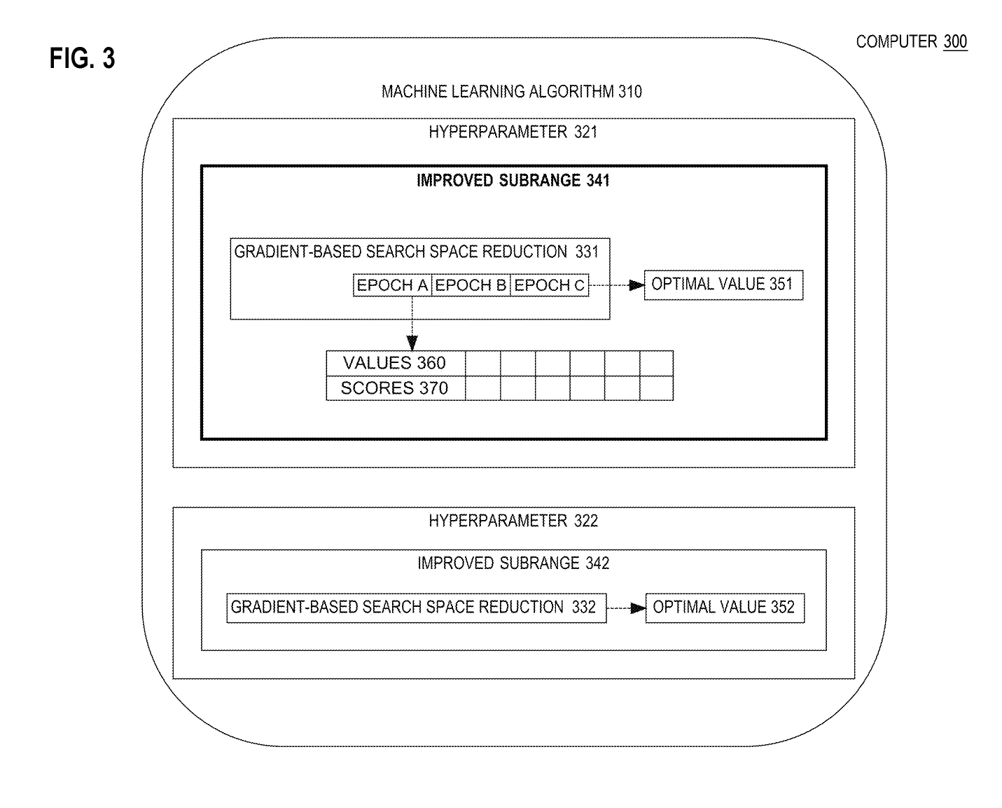

FIG. 3 is a block diagram that depicts an example computer 300, in an embodiment. Computer 300 performs a gradient-based search space reduction (GSSR) that is modified for use with an improved initial subrange of hyperparameter values. Computer 300 may be an implementation of computer 100.

GSSR can find an optimal value for a hyperparameter, as generally taught in the related patent application titled, “GRADIENT-BASED AUTO-TUNING FOR MACHINE LEARNING AND DEEP LEARNING MODELS.” As discussed below, generic GSSR is amenable to various substantial improvements disclosed herein.

Computer 300 may perform a GSSR for each hyperparameter of algorithm 310. For example, GSSRs 331-332 may perform value range narrowing for respective hyperparameters 341-342. After iterative range narrowing, GSSRs 331-332 may perform gradient ascent/descent to precisely find respective optimal values 351-352.

### 4.1 Local Extrema

Each hyperparameter, such as 321-322, of machine learning algorithm 310 has a natural range of values, which may be extensive or even intractable. Generic GSSR tries to approximate a global optimum value for a hyperparameter, but may instead be misled to a merely local optimum, of which a hyperspace may have many for each hyperparameter/dimension.

A most important enhancement of GSSR avoids local optima by beginning a search within an improved subrange instead of a full range of possible values for a hyperparameter. For example, GSSRs 331-332 may begin their searches within respective improved initial subranges 341-342. Improved initial subranges save training time and improve accuracy by helping GSSR find a truly optimal value for a hyperparameter.

However, improved subrange 341 is potentially imperfect itself. In an embodiment, GSSR 331 may stray outside of improved subrange 341 while exploring values for hyperparameter 321. For example, improved subrange 341 need not actually contain optimal value 351.

### 4.2 Epoch Sequence

Each of GSSRs 331-332 performs its own independent sequence of epochs. For example, GSSR 331 sequentially performs epochs A-C.

Each epoch successively narrows a current range (not shown) of possible values for a hyperparameter. For example, epoch A refines improved initial subrange 341 to obtain a narrower subrange that can be further narrowed by epoch B, thereby iteratively closing in upon optimal value 351.

Each epoch samples a same fixed amount of values of a hyperparameter. For example, epoch A samples values 360 within improved subrange 341.

How many values are in values 360 depends on the embodiment. Generic GSSR may limit the size of values 360 to match available processors such as CPU cores.

In an embodiment, GSSR 331 samples more (e.g. a multiple of) values than available processors. For example, values 360 may have at least thirty-two values.

### 4.3 Gradient

GSSR samples points in pairs that form lines that each have a gradient (i.e. slope), thereby revealing previously unknown topography within the hyperspace. How wide is each pair, in terms of linear separation of its two points, may impact the performance of GSSR, such that each hyperparameter may have its own optimal amount of separation.

Generic GSSR uses a same constant separation at all times for all hyperparameters, which is suboptimal. In an embodiment, GSSR 331 may independently tune/vary the separation of points in pairs for each hyperparameter.

GSSR 331 may initially calculate a different separation distance for each hyperparameter that is a small (e.g. likely too small) fraction of the extent (i.e. span between minimum and maximum values) of values of the hyperparameter. In an embodiment, the small fraction initially is a fraction of the full natural extent of the hyperparameter.

In an embodiment, the small fraction is instead initially a fraction of an improved initial subrange, such as 341. In an embodiment, the fraction is a constant percent that does not exceed a threshold such as 0.001 percent or a smaller threshold.

Computer 300 may examine the gradients of the sampling pairs of an epoch to detect whether or not the separation distance is too small. In an embodiment, when at least a threshold amount of pair gradients are exactly or nearly zero, then the separation distance is too small. In an embodiment, the threshold is a constant percent such as fifty percent or a greater threshold.

A separation distance that is too small in an epoch may be dynamically increased for subsequent epochs. In an embodiment, the dynamic increase is geometric such as a doubling.

In an embodiment, there also is an upper limit on how large may be the separation distance. In an embodiment, the separation distance is not increased to an amount that is beyond a threshold percent of the full or improved initial range. In an embodiment, the threshold percent may be one percent or a smaller threshold.

### 5.0 Dataset Sensitivity

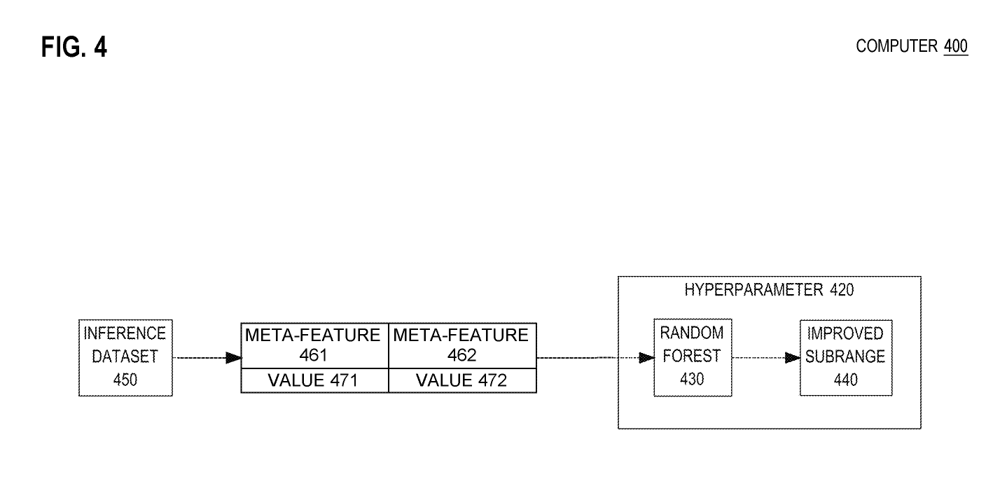

FIG. 4 is a block diagram that depicts an example computer 400, in an embodiment. Computer 400 predicts an improved value subrange that is sensitive to an actual dataset. Computer 400 may be an implementation of computer 100.

Computer 400 has a metamodel for each hyperparameter of a machine learning algorithm (not shown). For example, hyperparameter 420 has already trained random forest 430 as a dedicated metamodel that predicts improved subrange 440 for hyperparameter 420. A random forest is an ensemble of decision trees (not shown). An embodiment may use a learning algorithm other than a random forest, such as a neural network.

The full natural range of hyperparameter 420 is divided into a fixed number of contiguous equal segments (not shown). Each decision tree predicts (votes) which of the segments should be used as improved subrange 440.

The ensemble selects one of the predicted segments to become improved subrange 440. In an embodiment, the ensemble selects a statistically modal (i.e. most votes) segment. In an embodiment, an arithmetic mean of predicted segments is selected, which might have few or no votes.

### 5.1 Meta-Features

Datasets may be more or less different from each other. In various ways, distinctive features of a dataset may be measured, extracted, or otherwise derived.

Features of a dataset itself as a whole are referred to as meta-features. For example, inference dataset 450 has at least meta-features 461-462. Each meta-feature may be a dataset characteristic such as a statistical, information theoretic, or landmark feature.

For example if inference dataset 450 is a collection of photographs, then meta-feature 461 may be a count of photographs or an arithmetic mean of pixels per photo, and meta-feature 462 may be a statistical variance of all pixel luminosities of all of the photos or median count of edges of all photos, which may be somewhat rigorous to calculate. Computer 400 processes inference dataset 450 to obtain values 471-472 for respective meta-features 461-462.

### 5.2 Inference Dataset

Meta-feature values 471-472 may characterize inference dataset 450, such that somewhat similar datasets (such as monochrome photos) should have somewhat similar meta-feature values (such as color count). Likewise, different configuration alternatives of a machine learning algorithm may be more suited or less suited for analyzing various classes of datasets.

For example with hyperparameter 420, a first improved subrange may perform well for monochrome photos, and a second improved subrange may perform well for full-color photos. If inference dataset 450 mostly contains monochrome photos, then random forest 430 should select the first improved subrange.

### 5.3 Inferencing

By stimulating already-trained metamodels, such as 430, with meta-feature values of a new (unfamiliar) inference dataset such as 450, computer 400 may detect an optimally improved subrange for each hyperparameter. Thus, computer 400 (or a downstream computer) can efficiently initiate a gradient-based search space reduction by starting with an optimal improved subrange of contextually promising values based on dataset 450.

### 6.0 Metamodel Lifecycle

Techniques described herein achieve predictive metamodels. Only metamodels that predict an improved subrange are discussed above.

Discussed below are additional metamodels that may predict other data instead of an improved subrange, such as expected training duration or optimal separation distance between points of a sampling pair. All of these metamodels may have more or less similar lifecycles, including phases for training and inferencing.

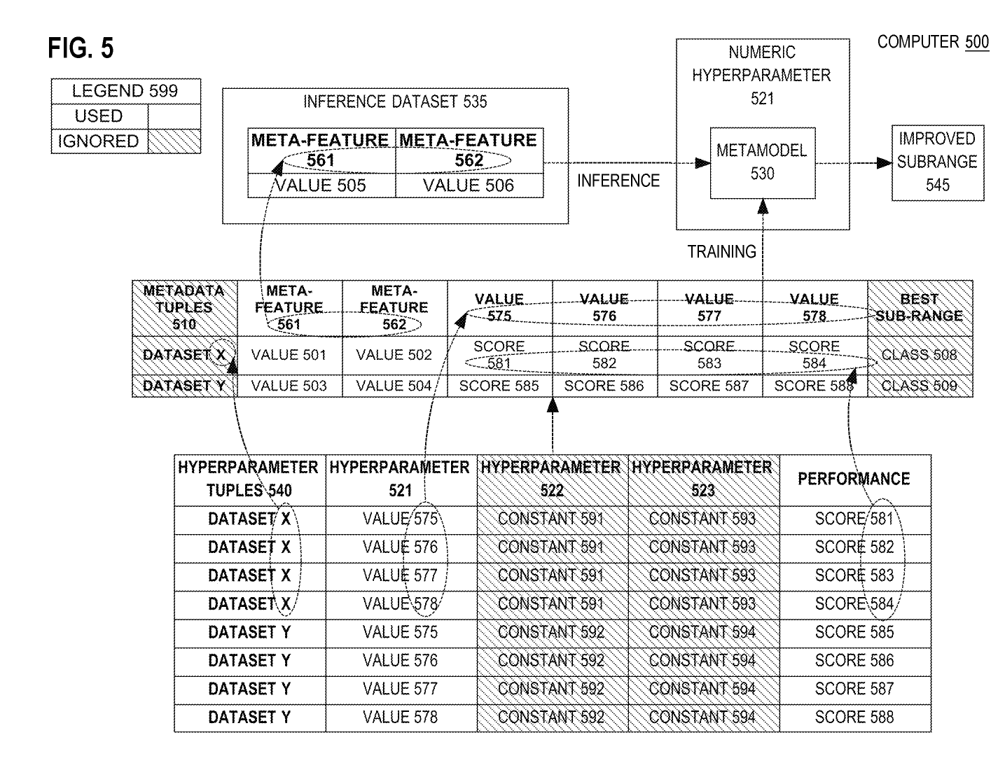

However, what data is used as inputs for training or inferencing may depend on what kind of prediction should be made by a metamodel. FIGS. 5, 7, 9, and 11 depict dataflow and lifecycle of a metamodel for various kinds of predictions.

Those figures share pictorial styles as follows. Metamodel training dataflow is upwards, from the bottom of the figure to the top of the figure, ending at the metamodel.

### 6.1 Metadata

In some embodiments as shown, metamodel training may consume data in a refactored format that differs from the format originally captured during exploratory training of a machine learning algorithm. Thus, an algorithm is reconfigured and trained repeatedly, which generates performance data, and then a metamodel is trained only once, based on the performance data.

The raw performance data of the algorithm is shown in a bottom table of hyperparameter tuples, which is then refactored into a middle table of metadata tuples. Although demonstratively helpful, representing more or less the same data in two different tabular formats may be unnecessary in practice, depending on the embodiment.

Each row of the bottom table of hyperparameter tuples contains performance data for a single training run of the algorithm (not the metamodel) based on a particular configuration of hyperparameter values and a particular training dataset. Whereas, each row (i.e. metadata tuple) of the middle table may consolidate one or more hyperparameter tuple rows, depending on the type of prediction.

The legends in those figures are the same. White table cells have data that flows upwards, either from the bottom table to the middle table, or from the middle table to the metamodel.

For example, white table cells of the middle table indicate actual training inputs for the metamodel. Shaded table cells have data that either does not flow upward, or does so only for purposes of testing, correcting, and feedback, such as a training prediction target, but not for direct stimulus.

Inferencing dataflow for an already trained metamodel is from left to right, passing through the metamodel, ending with a prediction or optimization, such as an improved subrange. Whether inferencing or training, each table's top row is a demonstrative header row (shown bold) that does not have actual data. Explanations of a particular dataflow for a metamodel of each kind of prediction is as follows for FIGS. 5-12.

### 7.0 Meta-Learning

FIG. 5 is a block diagram that depicts an example computer 500, in an embodiment. Computer 500 trains a hyperparameter metamodel to predict an improved subrange. Computer 500 may be an implementation of computer system 100.

Computer 500 trains a machine learning algorithm (not shown) to generate metadata for training metamodel 520. Thus, two different algorithms/models are trained in sequence.

The machine learning algorithm (not shown) may be repeatedly trained with a small fixed amount of exploratory values for hyperparameter 521, such as 575-578. The values of other hyperparameters, such as 522-523, are held constant during such training, such as 591-594. Thus, each row of hyperparameter tuples 540 records a training run based on a training configuration that achieves an observed performance of the training of the algorithm.

### 7.1 Scores

The machine learning algorithm (not shown) is repeatedly configured for hyperparameters 521-523, and each configuration is trained to process inputs, such as dataset X, to achieve a training performance score that indicates the comparative suitability of a distinct combination of values for the hyperparameters for dataset X.

Performance scores 581-588 share a performance measurement scale. For example, a score may predictively measure how proficient (accuracy such as error rate) would a particular configuration of the machine learning algorithm become after training for a fixed duration with a particular training dataset such as X or Y.

Likewise, a score may instead measure how much time does a particular configuration of a particular algorithm need to achieve a fixed proficiency for a particular training data set. Instead, a score may simply be a comparative measure of abstract suitability/fitness/accuracy. Regardless of score semantics, each training run of the machine learning algorithm achieves a training performance score.

### 7.2 Subrange Classification

As shown, hyperparameter tuples 540, metadata tuples 510, and metamodel 530 are dedicated to optimizing hyperparameter 521. As explained above, the full natural range of hyperparameter 521 is divided into a fixed number of contiguous equal segments (not shown).

Each of values 575-578 fall within one of those segments. Which segment is selected to be an improved subrange for hyperparameter 521 for dataset X depends on scores 581-584.

In an embodiment, scores 581-584 are sorted by magnitude. The highest (best) ten percent of scores occur within an ideal subrange (not shown) of more or less arbitrary width and position with the natural full range of hyperparameter 521.

That ideal subrange is independent of the aforementioned equal segments. However, one or more of those segments at least partially overlap with the ideal subrange.

In an embodiment, the segment that has the most linear overlap with the ideal subrange becomes the designated improved subrange for hyperparameter 521. In an embodiment, the segment that contains the most scores of the top ten percent of scores becomes the designated improved subrange. In either case and when there is a tie by two segments, the segment with the highest score becomes the designated improved subrange as a tie breaker.

### 7.3 Dataflow

Hyperparameter tuples 540 is used to synthesize metadata tuples 510. Rows of hyperparameter tuples 540 that are based on dataset X are combined to synthesize a single row for dataset X in metadata tuples 510.

Rows (not shown) of hyperparameter tuples 540 that are based on dataset Y are combined to synthesize another single row for dataset Y in metadata tuples 510. Thus, metadata tuples 510 has one row per training dataset, such as X-Y.

Scores in separate rows of hyperparameter tuples 540 for a same dataset are transposed to fill hyperparameter value columns 575-578 of the row for dataset X in metadata tuples 510. Thus, metadata tuples 510 represents hyperparameter tuples 540 in a format that is denser due to having fewer rows.

Metamodel 530 is trained with metadata tuples 510. The shaded columns are not used as training inputs, although some shaded columns may be used as training prediction target(s).

As explained above, the full natural range of hyperparameter 521 is divided into a fixed number of contiguous equal segments (not shown), one of which is selected as an improved subrange for hyperparameter 521 for each of datasets X-Y. Each of those segments is a value range class.

Thus, each row of metadata tuples 510 may have its range class be classified according to the row's scores, as described above for segments and ideal subranges. Metadata tuples 510 includes the class label of each dataset/row.

For example, dataset X has class label 508, which is a training target that designates a segment as the improved subrange for dataset X for hyperparameter 521. Thus, accuracy/error of a training response by metamodel 530 to each individual row of metadata tuples 510 may be detected and processed to accomplish learning in metamodel 530.

Training of metamodel 530 is more or less complete when metamodel 530 has trained with all rows of metadata tuples 510.

Inferencing may occur long after training metamodel 530. Inferencing entails making a prediction or optimization about an aspect of training the algorithm (not the metamodel) with a new (i.e. unfamiliar) dataset.

For example, inference dataset 535 has values 505-506 for respective meta-features 561-562 that may stimulate metamodel 530. That stimulation causes metamodel 530 to predict that improved subrange 545 is an optimal initial subrange for optimizing hyperparameter 521, such as with gradient-based search space reduction. Improved subrange 530 will always be one of the aforementioned equal segments, such as range class 508 or 509.

### 8.0 Example Metamodel Training Process

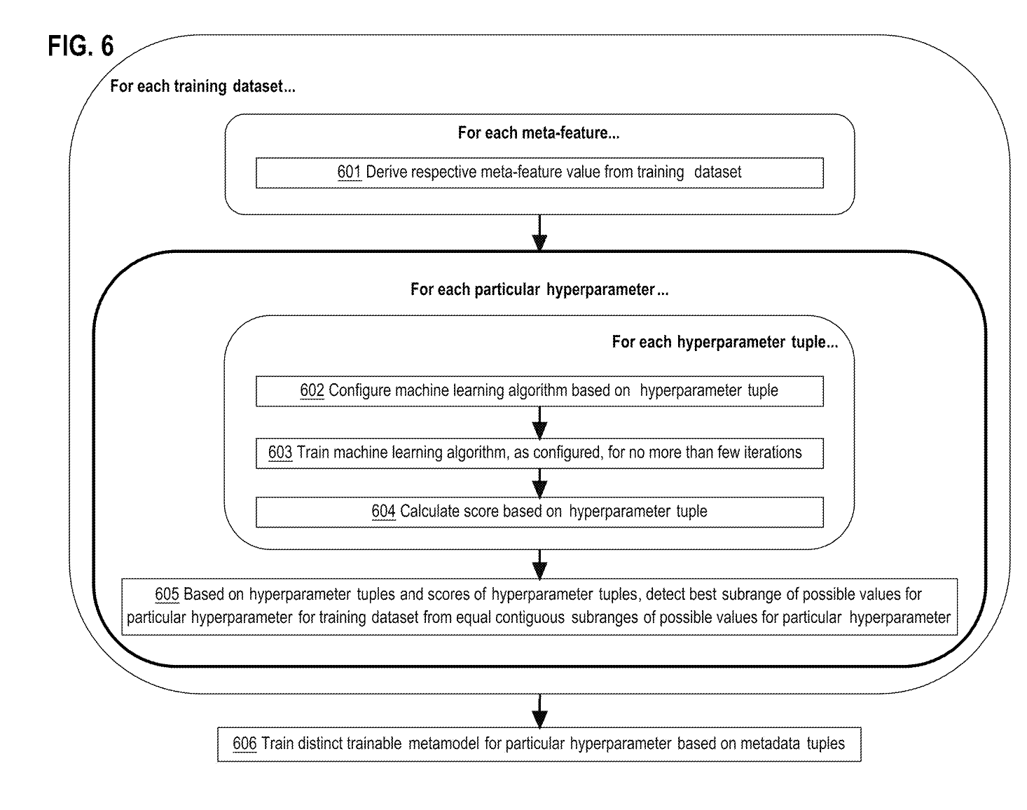

FIG. 6 is a flow diagram that depicts computer 500 training a hyperparameter metamodel to predict an improved subrange, in an embodiment. FIG. 6 is discussed with reference to FIG. 5.

Steps 601-605 are exploratory. Actual training of the metamodel does not occur until step 606.

Exploration is repeated for multiple training datasets. For example, cross validation may recombine portions (i.e. folds) of an original training dataset to synthesize training datasets X-Y. Steps 601-605 are repeated for each dataset.

Step 601 is preparatory. In step 601, a value for each meta-feature is obtained from the training dataset. For example, computer 500 extracts or otherwise derives values 505-506 for respective meta-features 561-562 from training dataset X.

Exploration is repeated for multiple hyperparameters of a machine learning algorithm. For example if the algorithm is a support vector machine, then c and gamma are hyperparameters.

Steps 602-605 are repeated for each numeric hyperparameter. As discussed later herein, categorical hyperparameters entail a different technique because they lack a gradient.

Steps 602-604 perform range sampling and range narrowing, such as during a sequence of gradient-based search space reduction (GSSR) epochs. In step 602, equally spaced pairs of points/values are sampled along the current subrange of the numeric hyperparameter.

Each point occurs along one dimension (i.e. a line) within a hyperspace of all hyperparameters. Computer 500 generates a hyperparameter tuple that represents each sampled point.

Each hyperparameter tuple has a value for each hyperparameter. For example, the bottom row of hyperparameter tuples 540 has values/constants 578, 592, and 594 for respective hyperparameters 521-523.

Steps 602-604 are repeated for each hyperparameter tuple. In step 602, the machine learning algorithm is configured according to the hyperparameter tuple.

Step 603 trains the configured machine learning algorithm for a few iterations. Full training would be slow.

Whereas, step 603 should be fast, because it may otherwise be the rate-limiting step in a metamodel training lifecycle. Rapid training of the algorithm should not exceed ten iterations or ten input stimulations.

Step 604 scores the hyperparameter tuple based on performance metrics of step 603, such as error/accuracy at the end of step 603. For example, hyperparameter tuples 540 receive performance scores 581-588. Step 604 creates one row within hyperparameter tuples 540 for each sample point.

After step 604 has finished for all sample points, computer 500 has completed multiple epochs and captured all of the raw data needed. Step 605 analyzes the raw data.

As explained above, the full natural range of values of a numeric hyperparameter is divided into contiguous equal segments. Step 605 detects which segment has the most overlap with the best ten percent of scores for a particular training dataset.

That best (most overlapping) segment becomes the range class for that dataset. For example, dataset X has range class 508.

Step 605 creates one row within metadata tuples 510 for each training dataset. Because each hyperparameter, such as 521, has its own separate metamodel, such as 530, each hyperparameter has its own separate table for metadata tuples and its own separate table for hyperparameter tuples. For example, tuple tables 510 and 540 are dedicated to hyperparameter 521.

After step 605 has finished for a particular numeric hyperparameter, a table of metadata tuples, such as 510, is fully populated and ready for training a metamodel in step 606. For example, data from each row of metadata tuples 510 is used as a training stimulus input for metamodel 530.

Step 606 is repeated for each hyperparameter, with each having its own metamodel. After step 606, the metamodel has been fully trained and is ready for inferencing new (i.e. unfamiliar) datasets, such as 535.

### 9.0 Categorical Hyperparameter

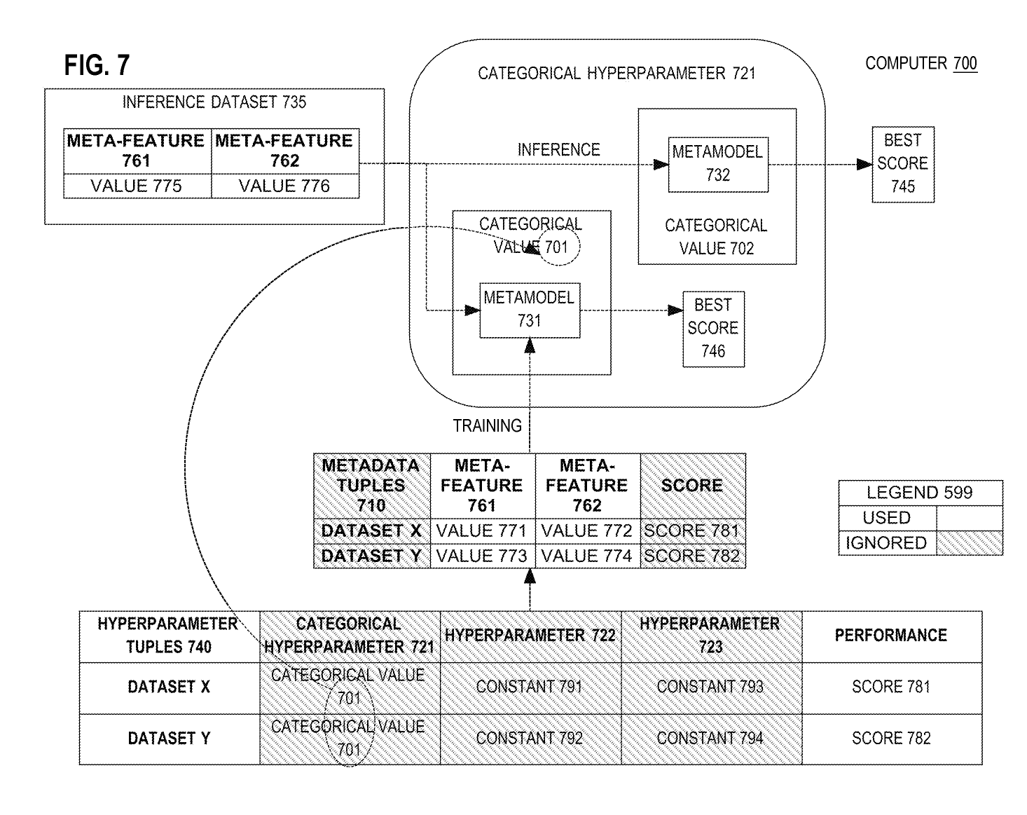

FIG. 7 is a block diagram that depicts an example computer 700, in an embodiment. Computer 700 trains a categorical hyperparameter metamodel to predict an optimal categorical value for the hyperparameter. Computer 700 may be an implementation of computer system 100.

Unlike numeric hyperparameters, not all hyperparameters have a reliable gradient. That is because, some hyperparameters lack a relative natural ordering of values that can provide a gradient.

Some hyperparameter types lack a monotonic value range that spans from a minimum value to a maximum value. Thus, some techniques herein based on gradients do not work for some types of hyperparameters.

Categorical (i.e. non-numeric, e.g. literal or symbolic) hyperparameters, such as 721, are not amenable to range narrowing and do not have their own epochs. For example, a Boolean hyperparameter lacks a meaningful gradient.

Even a many-valued symbolic hyperparameter (e.g. having values of seven geographic continents of Africa, Antarctica, Asia, Australia, Europe, North America, and South America) has no natural relative ordering of the values. Thus, a special technique is needed to explore categorical hyperparameters that is not based on gradient.

For example, the machine learning algorithm (not shown) may be an artificial neural network into which various optimizers may be plugged. The various optimizers are design/configuration alternatives that are interchangeable substitutes.

Thus, categorical hyperparameter 721 may have a distinct possible value for each kind of optimizer, such as stochastic gradient descent (SGD), adaptive movement estimation (Adam), adaptive gradient (AdaGrad), or root mean square propagation (RMSProp). For example, categorical values 701-702 may respectively represent AdaGrad and RMSProp.

### 9.1 Ensemble

Categorical hyperparameter 721 has a distinct metamodel for each possible categorical value. Each metamodel is trained to predict a best hypothetical score that could be achieved for a given dataset if hyperparameter 721 were set to a particular value.

For example, metamodels 731-732 are trained to predict respective best scores 746 and 745 when hyperparameter 721 is held constant with respective categorical value 701 or 702. During inferencing, all of metamodels 731-732 may be stimulated with same meta-feature values 775-776 of same inference dataset 735.

For that same stimulus, each of metamodels 731-732 emit a different predicted hypothetical best score, such as 745-746. Computer 700 selects the categorical value whose metamodel emits the highest predicted score, such as 745 as shown. Thus when computer 700 eventually configures the algorithm (not shown) for intensive training with inference dataset 735, then hyperparameter 721 should be held constant with the best categorical value, such as 702.

Hyperparameter tuples 740 is dedicated to synthesizing metadata tuples 710 for training metamodel 731. Metamodel 732 would use different tables (not shown) of hyperparameter tuples and metadata tuples, even though likely based on performance data from training the algorithm (not the metamodel) with same training datasets X-Y. Even though the training datasets may be shared, the training runs are different because the configuration value of at least hyperparameter 721 is different.

Each row of metadata tuples 710 is synthesized from a respective single row of hyperparameter tuples 740, with each row dedicated to a distinct training dataset such as X-Y. Only values of meta-features 761-762 are used as metamodel training inputs. Scores 781-782 in metadata tuples 710 are used for detecting and correcting training error, but not as stimulus inputs.

### 10.0 Example Category Optimization Process

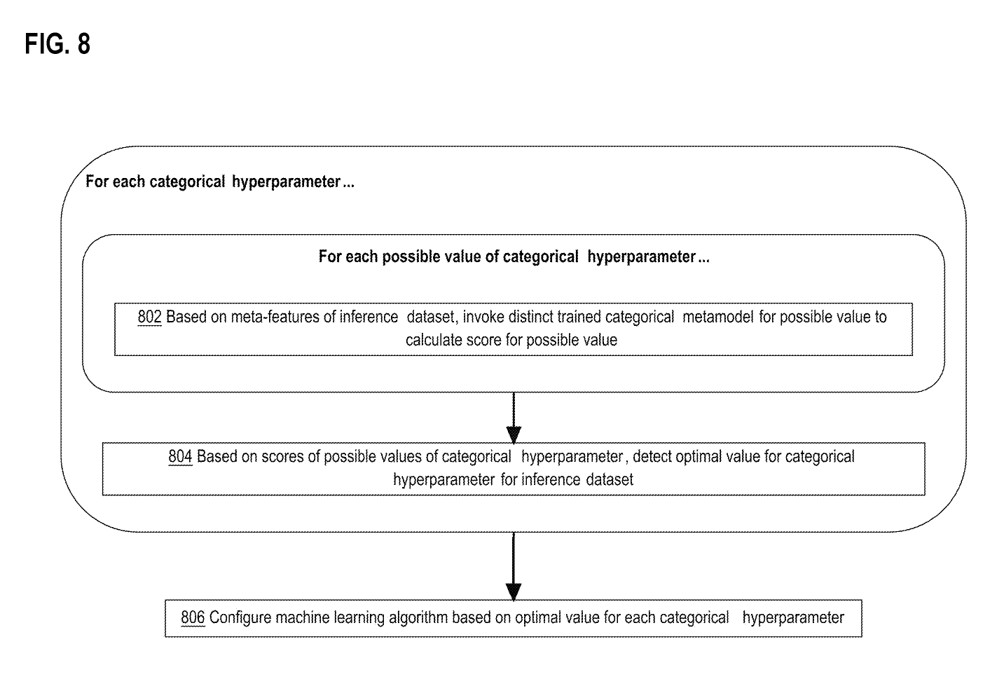

FIG. 8 is a flow diagram that depicts computer 700 stimulating multiple (e.g. ensemble of) already trained per-value categorical hyperparameter metamodels to predict an optimal categorical value for the hyperparameter for a given inference dataset, in an embodiment. FIG. 8 is discussed with reference to FIG. 7.

Unlike FIG. 6 that depicted metamodel training, FIG. 8 depicts inferencing by an already trained metamodel. For example, metamodels 731-732 are already trained and ready to predict best scores for a new (i.e. unfamiliar) inference dataset such as 735.

Inferencing occurs for each categorical hyperparameter, such 721. Thus, steps 802 and 804 are repeated for each categorical hyperparameter.

Each possible value of a categorical hyperparameter has its own metamodel. Thus, step 802 is repeated for each possible value.

In step 802, a metamodel of one possible value of the categorical hyperparameter is invoked to emit a best hypothetical score for the inference dataset for the possible value. For example, values 775-776 of respective meta-features 761-762 for inference dataset 735 are injected as stimulus inputs into both of metamodels 731-732. Metamodels 731-732 calculate respective best hypothetical scores 745-746, based on meta-feature values 775-776.

Metamodels 731-732 participate only at step 802. Steps 804 and 806 process the results emitted by metamodels 731-732.

In step 804, the categorical value of the metamodel that emitted the highest score is selected. For example, computer 700 detects that best score 745 is highest and selects categorical value 702 as the optimal value for categorical hyperparameter 721 for inference dataset 735.

Such optimal values are selected for all categorical hyperparameters (and for all numeric hyperparameters in a different way) before step 806. In step 806, the machine learning algorithm is configured with an optimal value for each hyperparameter.

Thus, the algorithm is fully configured during step 806. Step 806 may also use inference dataset 735 to intensively train the algorithm (not the metamodel). Thus after step 806, the algorithm may be already trained and ready for production deployment and/or use.

### 11.0 Sampling Optimization

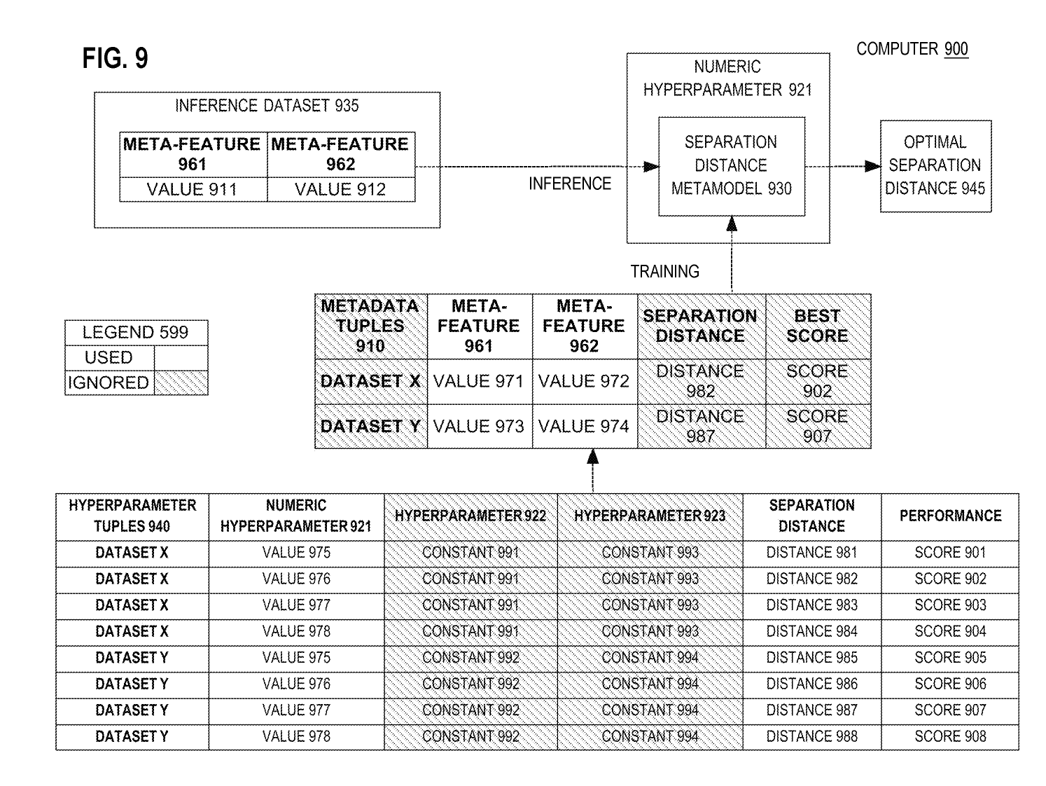

FIG. 9 is a block diagram that depicts an example computer 900, in an embodiment. Computer 900 trains a hyperparameter metamodel to predict an optimal separation distance between points of a sampling pair for the hyperparameter. Computer 900 may be an implementation of computer system 100.

As discussed above, separation distance may be dynamically tuned during an epoch sequence, which has the disadvantage of using suboptimal separation distances during early epochs until an optimal separation distance is eventually dynamically achieved. Whereas, metamodel 930 may predict an optimal separation distance, such as 945, for a particular hyperparameter, such as 921, for a new (i.e. unfamiliar) inference dataset, such as 935, before an epoch sequence begins for the new dataset.

While training various configurations of the algorithm (not the metamodel) with various training datasets, such as X-Y, a best score for each training run is recorded, such as 901-908. The separation distance between points of a pair may be dynamically tuned during those training runs. When a best score, such as 901-908, is achieved, the current separation distance is also recorded, such as 981-988.

In an embodiment, the best score is the highest score of an entire epoch sequence. In an embodiment, the best score is the most improved score during any epoch of the sequence, as compared to the best score of the previous epoch.

For each training dataset X-Y, a best achieved score is selected, such as scores 902 and 907 for respective datasets X-Y as shown in metadata tuples 910. The two rows of hyperparameter tuples 940 that achieved those scores are each used to synthesize a respective single row of metadata tuples 910.

Only values of meta-features 961-962 are used as metamodel training inputs. Separation distances 982 and 987 in metadata tuples 710 are used for detecting and correcting training error, but not as stimulus inputs.

### 12.0 Example Gradient Prediction Process

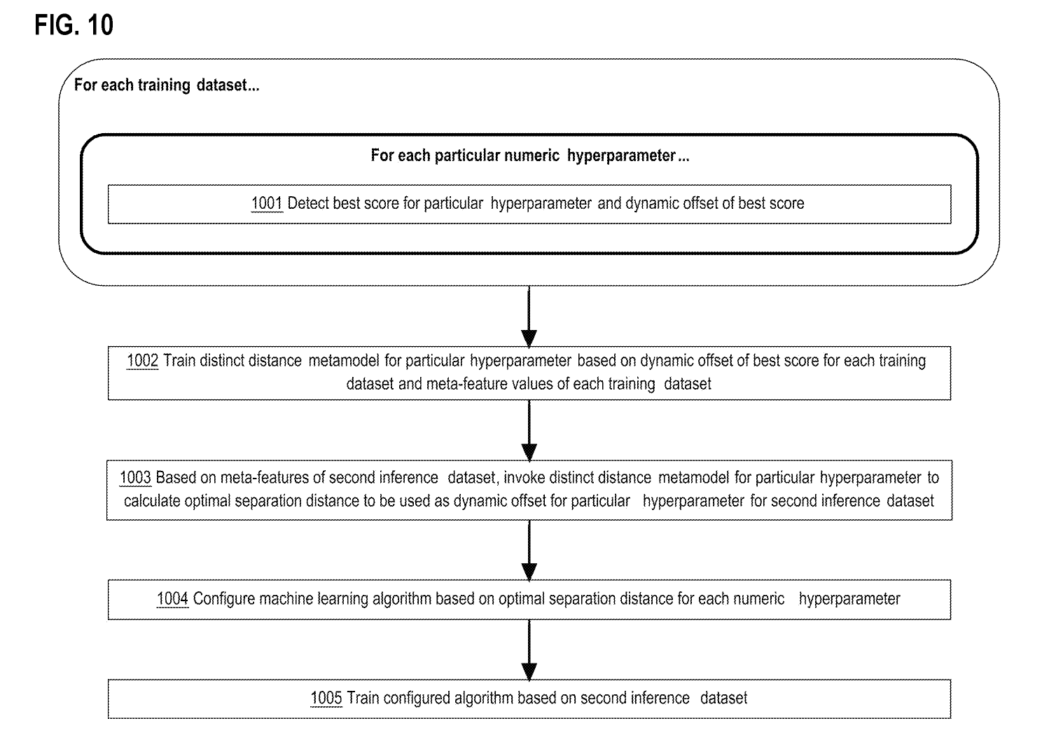

FIG. 10 is a flow diagram that depicts computer 900 training a numerical hyperparameter metamodel to predict an optimal separation distance between points of a pair for the hyperparameter, in an embodiment. FIG. 10 is discussed with reference to FIG. 9.

Distance exploration occurs for each training dataset. Thus, step 1001 is repeated for each training dataset.

Distance exploration occurs for each numeric hyperparameter. Thus, step 1001 is repeated for each numeric hyperparameter.

Step 1001 may occur during an epoch sequence of an independent gradient-based search space reduction (GSSR) for each numeric hyperparameter. Each GSSR detects a best achieved score, which is achieved during some epoch of the sequence when the dynamic offset has a particular value.

For example, step 1001 may populate hyperparameter tuples 940 for numeric hyperparameter 921. For each training dataset, such as X-Y, computer 900 may synthesize a row in metadata tuples 910 based on the highest scoring row of hyperparameter tuples 940 for that training dataset. Thus, all exploration occurs during step 1001, and step 1001 fully populates tuple tables 910 and 940.

Steps 1002-1003 are separately repeated for each numeric hyperparameter. Each numeric hyperparameter has its own distance metamodel that needs training.

In step 1002, a distance metamodel of the numeric hyperparameter is trained based on the meta-feature values of each training dataset and the dynamic offsets of the best scores. For example, data from metadata tuples 910 is injected as training stimulus inputs into distance metamodel 930.

After step 1002 finishes, the distance metamodel has been fully trained and is ready for eventual use during inferencing by step 1003. In step 1003, an already trained distance metamodel is eventually invoked, based on meta-feature values of a new inference dataset, to calculate an optimal separation distance to be used as the dynamic offset for a particular hyperparameter for the new inference dataset.

For example, values 911-912 of respective meta-features 961-962 for inference dataset 935 are injected as stimulus inputs into distance metamodel 930. Metamodel 930 reacts by emitting optimal separation distance 945.

In step 1004, the machine learning algorithm (not the metamodel) is configured based on the optimal separation distances that were predicted for each hyperparameter in step 1003. That includes configuring the algorithm to accept the optimal separation distance of a hyperparameter as the dynamic offset for exploring the hyperparameter.

Thus, step 1004 fully configures the algorithm. In step 1005, the new inference dataset is used to train the configured algorithm.

Thus, step 1005 fully trains the machine learning algorithm. After step 1005, the trained algorithm is ready for production use.

### 13.0 Training Budget

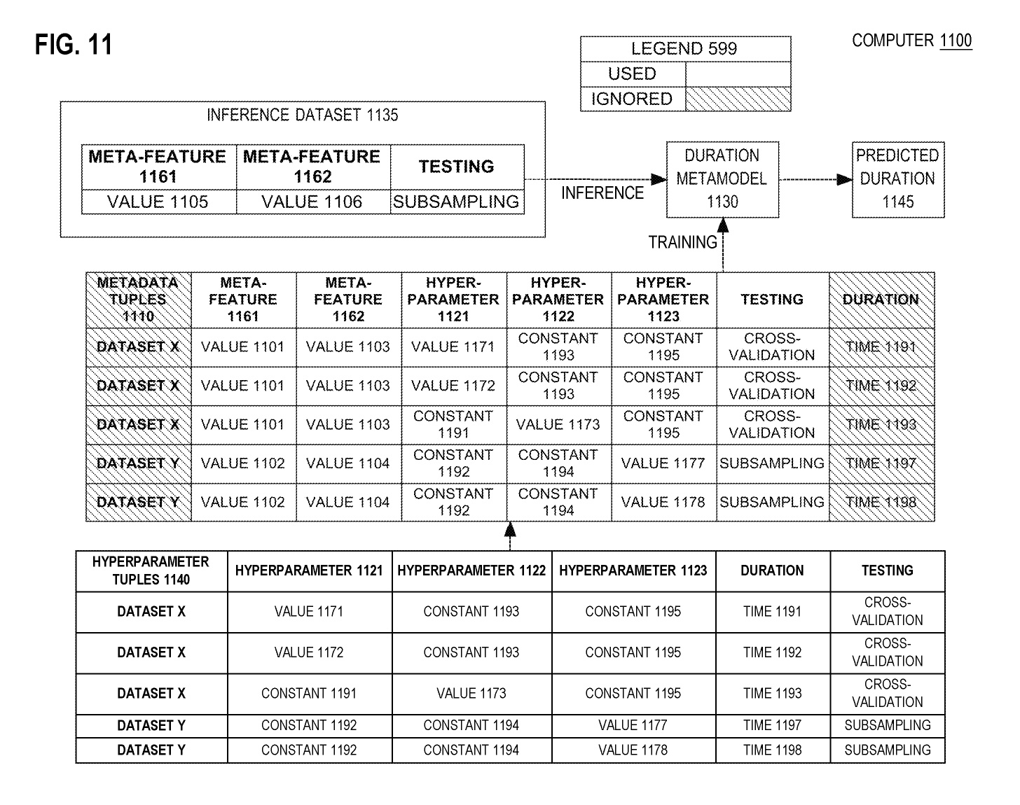

FIG. 11 is a block diagram that depicts an example computer 1100, in an embodiment. Computer 1100 trains a metamodel to predict a duration needed to train a machine learning algorithm with a given configuration for a given training dataset. Computer 1100 may be an implementation of computer 100.

Unlike the other hyperparameter tuple tables of FIGS. 5, 7, and 9, hyperparameter tuples 1140 may contain rows from explorations of different hyperparameters. For example, the rows of hyperparameter tuples 1140 for dataset X each represent an exploration of a hyperparameter of 1121-1123.

Because an exploration entails training various configurations of the algorithm (not the metamodel), exploration may be somewhat slow. Each row of hyperparameter tuples 1140 may be an interesting training run that occurred during exploration.

In an embodiment, hyperparameter tuples 1140 has rows for exploratory trainings that achieved a best score or took the most time to train, such as times 1191-1198. Also recorded in each row of hyperparameters 1140 is which testing method was used for evaluation while training the algorithm.

For example as shown, dataset X was tested using cross validation. Whereas, dataset Y was instead tested by subsampling. Different test methods may have significantly different test durations for a same training dataset.

Unlike the other metadata tuple tables of FIGS. 5, 7, and 9, metadata tuples 1110 contain actual hyperparameter values. Thus, duration metamodel 1130 is sensitive to the configuration of the machine learning algorithm (not the metamodel), in addition to being sensitive to the meta-feature values of a dataset.

That is because algorithm configuration impacts algorithm training duration, which is what duration metamodel 1130 learns to predict. As shown, values of meta-features 1161-1162, values of all hyperparameters 1121-1123, and the particular testing method are all training stimulus inputs for duration metamodel 1130.

Unlike the metamodels of FIGS. 5, 7, and 9, the machine learning algorithm (not shown) of FIG. 11 has only one metamodel, which learns for all hyperparameters. Durations 1191-1198 are not training inputs, but may be used for error detection and correction while training duration metamodel 1130.

Later during inferencing, such as with inference dataset 1135, meta-feature values and testing method are injected as stimulus inputs into already trained duration metamodel 1130 to predict training duration 1145 for inference dataset 1135. Although not shown, the actual values of hyperparameters used to configure the machine learning algorithm are also injected as stimulus inputs into already trained duration metamodel 1130 to predict training duration 1145. Thus, predicted training duration 1145 is sensitive to meta-features of an inference dataset and sensitive to actual configuration of the machine learning algorithm.

### 14.0 Example Duration Prediction Process

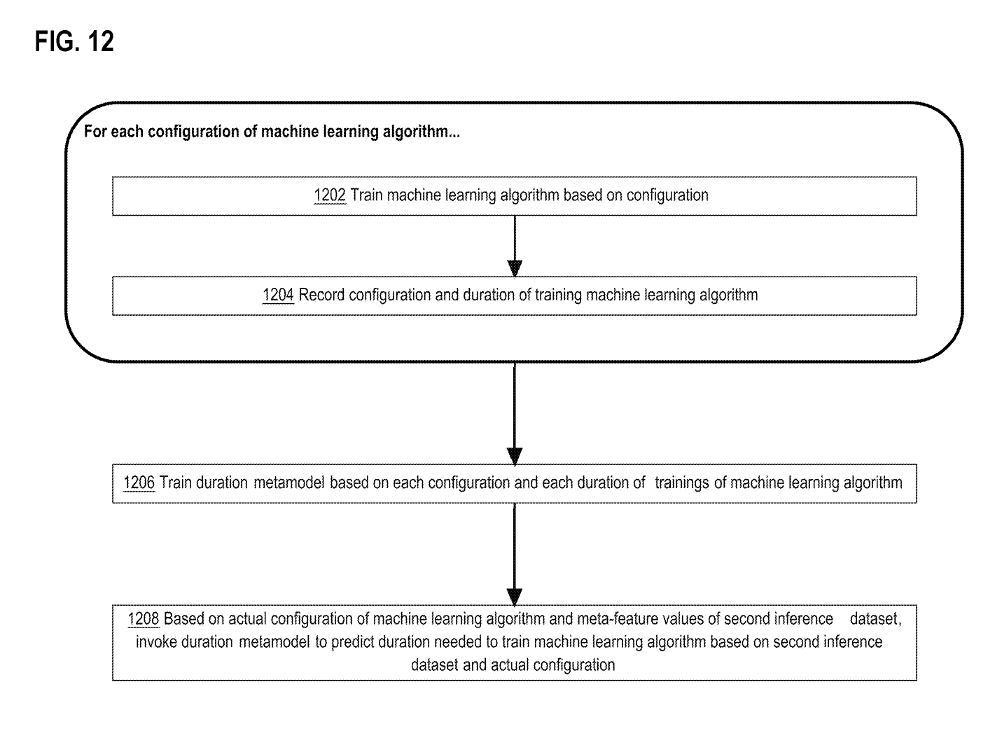

FIG. 12 is a flow diagram that depicts computer 1100 training a metamodel to predict a duration needed to train a machine learning algorithm with a given configuration for a given training dataset, in an embodiment. FIG. 12 is discussed with reference to FIG. 11.

Although configuration exploration occurs independently for each hyperparameter, in toto, many hyperparameter tuples (configurations) may be evaluated. Some or all of those configurations (i.e. hyperparameter tuples 1140 refactored as metadata tuples 1110) may be used to train duration metamodel 1130.

Thus, steps 1202 and 1204 are repeated for each configuration. Steps 1202 and 1204 perform the configuration exploration, such as with independent epoch sequences and GSSR.

Per GSSR, each sampled configuration is evaluated (i.e. scored) by using the configuring the machine learning algorithm with the configuration and then quickly training the configured algorithm during step 1202. For example, each row of hyperparameter tuples 1140 contains a distinct sampled training/testing configuration of the algorithm.

Each row of hyperparameter tuples 1140 also measures how long did training during step 1202 take, such as durations 1191-1198. Each repetition of step 1204 creates a row in hyperparameter tuples 1140. Some or all of those rows may be refactored to become rows of metadata tuples 1110.

After steps 1202 and 1204, exploratory/sample training is finished and tuple tables 1110 and 1140 are fully populated. Duration metamodel training occurs during step 1206, and duration inferencing occurs during step 1208.

Step 1206 trains the duration metamodel based on each training configuration and each duration of the trainings of the machine learning algorithm. For example, the actual values of meta-features 1161-1162 and hyperparameters 1121-1123 and an actual testing method are taken from metadata tuples 1110 and injected into duration metamodel 1130 as training stimulus inputs. After step 1206, duration metamodel 1130 is fully trained and ready for inferencing.

In step 1208, based on an actual configuration of the machine learning algorithm and meta-feature values of a new inference dataset, the duration metamodel is invoked to predict a duration needed to train the machine learning algorithm, as configured, based on the new inference dataset. For example, duration metamodel 1130 may predict duration 1145 when stimulated with inputs that include values 1105-1106 of respective meta-features 1161-1162 of inference dataset 1135, actual values of hyperparameters 1121-1123, and an actual testing method.

In one scenario, predicted duration 1145 is used to optimally schedule computer resources. In another scenario, step 1208 is repeated for various configurations, and a configuration that is fastest (or fast enough) to train is selected for actual training of the machine learning algorithm with inference dataset 1135.

### 15.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

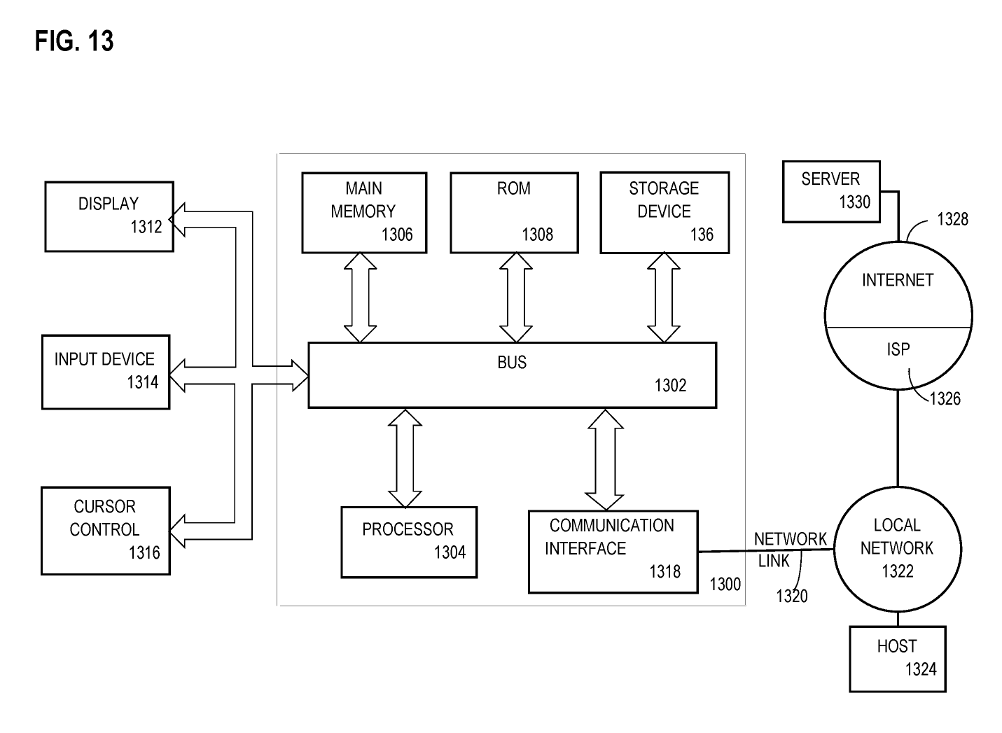

For example, FIG. 13 is a block diagram that illustrates a computer system 1300 upon which an embodiment of the invention may be implemented. Computer system 1300 includes a bus 1302 or other communication mechanism for communicating information, and a hardware processor 1304 coupled with bus 1302 for processing information. Hardware processor 1304 may be, for example, a general purpose microprocessor.

Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 136, such as a magnetic disk or optical disk, is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 136. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 136. Volatile media includes dynamic memory, such as main memory 1306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 136 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 136, or other non-volatile storage for later execution.

### 16.0 Software Overview

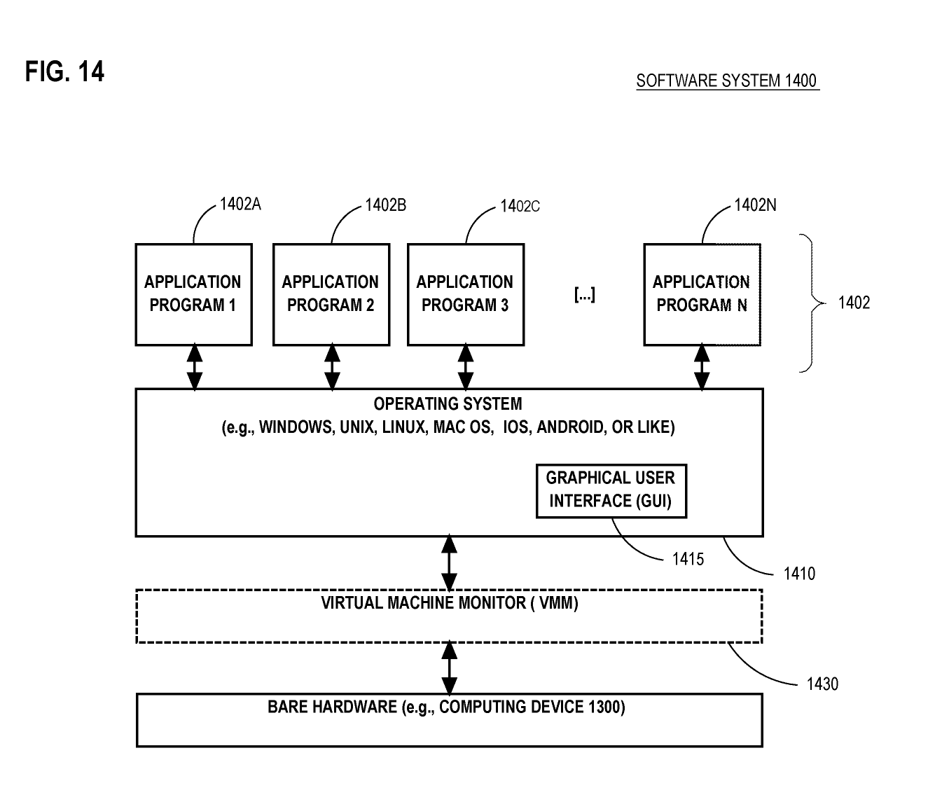

FIG. 14 is a block diagram of a basic software system 1400 that may be employed for controlling the operation of computing system 1300. Software system 1400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1400 is provided for directing the operation of computing system 1300. Software system 1400, which may be stored in system memory (RAM) 1306 and on fixed storage (e.g., hard disk or flash memory) 136, includes a kernel or operating system (OS) 1410.

The OS 1410 manages low-level aspects of computer operation, including managing execution of processes, memory allocation, file input and output (I/O), and device I/O. One or more application programs, represented as 1402A, 1402B, 1402C . . . 1402N, may be “loaded” (e.g., transferred from fixed storage 136 into memory 1306) for execution by the system 1400. The applications or other software intended for use on computer system 1300 may also be stored as a set of downloadable computer-executable instructions, for example, for downloading and installation from an Internet location (e.g., a Web server, an app store, or other online service).

Software system 1400 includes a graphical user interface (GUI) 1415, for receiving user commands and data in a graphical (e.g., “point-and-click” or “touch gesture”) fashion. These inputs, in turn, may be acted upon by the system 1400 in accordance with instructions from operating system 1410 and/or application(s) 1402. The GUI 1415 also serves to display the results of operation from the OS 1410 and application(s) 1402, whereupon the user may supply additional inputs or terminate the session (e.g., log off).

OS 1410 can execute directly on the bare hardware 1420 (e.g., processor(s) 1304) of computer system 1300. Alternatively, a hypervisor or virtual machine monitor (VMM) 1430 may be interposed between the bare hardware 1420 and the OS 1410. In this configuration, VMM 1430 acts as a software “cushion” or virtualization layer between the OS 1410 and the bare hardware 1420 of the computer system 1300.

VMM 1430 instantiates and runs one or more virtual machine instances (“guest machines”). Each guest machine comprises a “guest” operating system, such as OS 1410, and one or more applications, such as application(s) 1402, designed to execute on the guest operating system. The VMM 1430 presents the guest operating systems with a virtual operating platform and manages the execution of the guest operating systems.

In some instances, the VMM 1430 may allow a guest operating system to run as if it is running on the bare hardware 1420 of computer system 1400 directly. In these instances, the same version of the guest operating system configured to execute on the bare hardware 1420 directly may also execute on VMM 1430 without modification or reconfiguration. In other words, VMM 1430 may provide full hardware and CPU virtualization to a guest operating system in some instances.

In other instances, a guest operating system may be specially designed or configured to execute on VMM 1430 for efficiency. In these instances, the guest operating system is “aware” that it executes on a virtual machine monitor. In other words, VMM 1430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### 17.0 Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
for each particular hyperparameter of a plurality of hyperparameters of a machine learning algorithm, invoking, based on an inference dataset, a distinct trained metamodel for the particular hyperparameter to detect an improved subrange of possible values for the particular hyperparameter;
configuring, based on said improved subranges of possible values for the plurality of hyperparameters, the machine learning algorithm;
invoking the machine learning algorithm to obtain a result.

2. The method of claim 1 wherein said configuring the machine learning algorithm based on said improved subranges of possible values for the plurality of hyperparameters comprises for each particular hyperparameter of a plurality of hyperparameters that is not a categorical hyperparameter, performing:
based on said improved subrange of possible values for the particular hyperparameter, a gradient-based search space reduction to detect an optimal value for the particular hyperparameter;
configuring the machine learning algorithm based on the optimal value for the particular hyperparameter.

3. The method of claim 2 wherein the optimal value for the particular hyperparameter is not within said improved subrange of possible values for the particular hyperparameter.

4. The method of claim 2 wherein:
the gradient-based search space reduction comprises a sequence of epochs for the particular hyperparameter;
wherein a same fixed amount of at least thirty-two values of the particular hyperparameter are sampled during each epoch of the sequence of epochs.

5. The method of claim 4 wherein:
a respective score is calculated for each value of said at least thirty-two values;
a first half of said at least thirty-two values are equally spaced in a dynamic value range for the epoch;
a second half of said at least thirty-two values are based on adding a dynamic offset to each value of said first half of said at least thirty-two values;
the dynamic offset is increased when a threshold is exceeded by an amount of value pairs having a zero gradient in an immediately previous epoch of the sequence of epochs.

6. The method of claim 5 wherein the threshold is at least fifty percent.

7. The method of claim 5 wherein the dynamic offset is increased comprises the dynamic offset is at least doubled.

8. The method of claim 5 wherein the dynamic offset is initially at most 0.001 percent of an initial dynamic value range for the epoch.

9. The method of claim 5 wherein the dynamic offset is increased comprises the dynamic offset is increased without exceeding at most one percent of an initial dynamic value range for the epoch.

10. The method of claim 5 further comprising:
for each training dataset of a plurality of training datasets, training a distinct distance metamodel for the particular hyperparameter based on said dynamic offset for said respective score that is a best score for the particular hyperparameter for the training dataset;
invoking, based on meta-features of a second inference dataset, the distinct distance metamodel for the particular hyperparameter to calculate an optimal separation distance to be used as said dynamic offset for the particular hyperparameter for the second inference dataset.

11. The method of claim 1 wherein said invoking said distinct trained metamodel based on an inference dataset comprises:
deriving a plurality of meta-feature values from the inference dataset by, for each meta-feature of a plurality of meta-features, deriving a respective meta-feature value from the inference dataset;
invoking said distinct trained metamodel based on the plurality of meta-feature values.

12. The method of claim 1 further comprising training the distinct trained metamodel for the particular hyperparameter based on a plurality of metadata tuples, wherein each metadata tuple of the plurality of metadata tuples comprises:
a training plurality of meta-feature values of a training dataset, and
a best subrange of possible values for the particular hyperparameter for the training dataset.

13. The method of claim 12 further comprising, for each training dataset of a plurality of training datasets:
deriving a plurality of meta-feature values for the training dataset by, for each meta-feature of a plurality of meta-features, deriving a respective meta-feature value from the training dataset;
for each particular hyperparameter of a plurality of hyperparameters that is not a categorical hyperparameter, processing the training dataset for the particular hyperparameter by:
for each hyperparameter tuple of a plurality of hyperparameter tuples, calculating a score based on the hyperparameter tuple, wherein the hyperparameter tuple contains a value of said particular hyperparameter; and
detecting, based on said plurality of hyperparameter tuples and said scores of said plurality of hyperparameter tuples, said best subrange of possible values for the particular hyperparameter for the training dataset from a plurality of equal contiguous subranges of possible values for the particular hyperparameter.

14. The method of claim 13 wherein said calculating the score based on the hyperparameter tuple comprises:
configuring said machine learning algorithm based on the hyperparameter tuple, and
training said machine learning algorithm, as configured, for no more than ten iterations.

15. The method of claim 1 further comprising, for each categorical hyperparameter of one or more categorical hyperparameters:
for each possible value of the categorical hyperparameter, invoking, based on meta-features of the inference dataset, a distinct trained categorical metamodel for the possible value to calculate a score for the possible value;
detecting, based on said scores of the possible values of the categorical hyperparameter, an optimal value for the categorical hyperparameter for the inference dataset;
wherein said configuring said machine learning algorithm is based on the optimal value for each categorical hyperparameter of the one or more categorical hyperparameters.

16. The method of claim 15 wherein:
the machine learning algorithm is an artificial neural network (ANN);
said one or more categorical hyperparameters comprises an optimizer hyperparameter that has at least two possible values of: stochastic gradient descent (SGD), adaptive movement estimation (Adam), adaptive gradient (AdaGrad), and root mean square propagation (RMSProp).

17. The method of claim 1 wherein the distinct trained metamodel for the particular hyperparameter comprises a distinct random forest regressor.

18. The method of claim 1 further comprising:
for each configuration of a plurality of configurations of the machine learning algorithm:
training the machine learning algorithm based on the configuration; and
recording the configuration and a duration of the training of the machine learning algorithm;
training a duration metamodel based on each configuration and each duration of the training of the machine learning algorithm;
invoking, based on an actual configuration of the machine learning algorithm and meta-feature values of a second inference dataset, the duration metamodel to predict a duration needed to train the machine learning algorithm based on the second inference dataset and the actual configuration, wherein the actual configuration comprises an actual value for each hyperparameter of the plurality of hyperparameters and/or an actual testing method of a plurality of testing methods.

19. One or more non-transitory computer-readable media storing instructions that, when executed by one or more processors, cause:
for each particular hyperparameter of a plurality of hyperparameters of a machine learning algorithm, invoking, based on an inference dataset, a distinct trained metamodel for the particular hyperparameter to detect an improved subrange of possible values for the particular hyperparameter;
configuring, based on said improved subranges of possible values for the plurality of hyperparameters, the machine learning algorithm;
invoking the machine learning algorithm to obtain a result.

20. Theo or more non-transitory computer-readable media of claim 19 wherein the instructions further cause training the distinct trained metamodel for the particular hyperparameter based on a plurality of metadata tuples, wherein each metadata tuple of the plurality of metadata tuples comprises:
a training plurality of meta-feature values of a training dataset, and
a best subrange of possible values for the particular hyperparameter for the training dataset.
